(19) United States
(12) Patent Application Publication
(10) Pub. No.: US 2023/0078829 A1
(43) Pub. Date: Mar. 16, 2023

(54) AGRICULTURE STEWARDSHIP METHOD

(71) Applicant: Agriculture Prosperity Solutions Inc., Fargo, ND (US)

(72) Inventors: Mark Deutschman, Maple Grove, MN (US); Charles Fritz, Detroit Lakes, MN (US)

(21) Appl. No.: 17/901,343

(22) Filed: Sep. 1, 2022

Related U.S. Application Data
(60) Provisional application No. 63/240,397, filed on Sep. 3, 2021.

(51) Int. Cl. G06Q 50/02; G06Q 10/06

(52) U.S. Cl. CPC G06Q 50/02; G06Q 10/063

(57) ABSTRACT

A method of deriving a field stewardship rating using a set of indices obtained from an agricultural operation which may consist of a single farm field, a combination of multiple farm fields within a farming operation, or a combination of farming operations. The indices may consist of quantitative and semi-quantitative values derived from farming operations, physical characteristics of the field, type of crops planted, methods used to till the soil, use of conservation practices, and residue amounts on the soil surface; a field stewardship rating falls into a range from 0 to 10. A further method of using a field stewardship rating may include comparing farm operations, improving farm operations, branding farm operations and their products, estimating environmental outcomes of a farm operation, and developing strategies to improve water management and quality of farm operations.

### FIELD

This disclosure relates to agriculture stewardship, particularly to stewardship of farm fields, farms, and agricultural producers within agriculture operations by a method of obtaining a quantitative field stewardship rating derived from a set of indices and methods to use the field stewardship rating.

### BACKGROUND

In recent years there have been many “sustainable agriculture” efforts, for example, the Field to Market and Minnesota Agriculture Water Quality Certification programs. These practices are largely propelled through the use of performance criteria or qualitative indexes. Such methods try to assist agriculture operations in achieving their goals for soil, water, and land management in regard to their environmental impact on water quality.

Current sustainability efforts lack the ability to predict a relationship between stewardship quality and water usage and quality with the techniques applied by an agricultural producing operation. The current methods do not employ the plethora of data available to accurately predict outcomes from a stewardship system. Such available data can include how crops can be planted, the tillage system used in the preparation of planting a field, weed management of a planted field, irrigation process used on a field, and the use of management and structural conservation practices, e.g., cover crops.

Another significant issue with current methods is that they do not allow for an accurate prediction in water management outcomes when an agricultural producer changes their operation. For example, the Field to Market and Minnesota Agriculture Water Quality Certification lacks the ability to account for changes in water retained by the soil, the amount of surface water runoff, the amount of soil mobilized by sheet and rill erosion, the amount of soil transported downstream, and the amount of total phosphorus mobilized and transported downstream.

Additionally, currently available methods lack the ability to compare agricultural operations that include fields with different physical characteristics (e.g., variations in soil types, slopes), farms comprising multiple fields, and agricultural producers. The currently available methods also lack the ability to quantify data from the amount of water retained by the soil, the amount of surface water runoff, the amount of soil mobilized by sheet and rill erosion, the amount of soil transported downstream, and the amount of total phosphorus mobilized and transported downstream. With the current methods, agricultural producers cannot understand the relationship between their farming methods, their level of “sustainability” or stewardship, and water outcomes.

### SUMMARY

According to this disclosure, an embodiment for a method to derive a Field Stewardship Rating (“FSR”) as a single number with a value ranging from 0 to 10 for a farm field comprises the determination of indices in the following manner: calculating a soil water erosion benchmark index; calculating a soil water erosion departure index for agriculture; calculating a soil retention benchmark index; calculating a infiltration benchmark index; calculating a runoff departure index for agriculture; calculating a total phosphorous mobilization index for agriculture; calculating a total phosphorous export index for agriculture; calculating a total phosphorous export departure index for agriculture; calculating a total phosphorous retention benchmark index; assigning a numeric score of 0 to 10, for a risk category for a resource sediment goal (index); assigning a numeric score of 0 to 10, for a method to achieve category for a sediment goal feasibility (index); assigning a numeric score of 0 to 10, for a risk category for a resource phosphorous goal (index); assigning a numeric score of 0 to 10, for a method to achieve category for a phosphorous goal feasibility (index); assigning a numeric score of 0 to 10, for a category method for a 4r nitrogen fertilizer index; assigning a numeric score of 0 to 10, for a category method for a 4r phosphorous fertilizer index; then averaging all the indices to derive a range of agriculture for the agriculture operation.

In another embodiment of the present disclosure, an FSR is derived as a single number with a value ranging from 0 to 10 for an irrigated farm field by taking the following steps: calculating an irrigation water use efficiency benchmark index; calculating a soil water erosion benchmark index; calculating a soil water erosion departure index for agriculture; calculating a soil retention benchmark index; calculating a infiltration benchmark index; calculating a runoff departure index for agriculture; calculating a total phosphorous mobilization index for agriculture; calculating a total phosphorous export index for agriculture; calculating a total phosphorous export departure index for agriculture; calculating a total phosphorous retention benchmark index; assigning a numeric score of 0 to 10 for a risk category for a resource sediment goal (index); assigning a numeric score of 0 to 10 for a method to achieve category for a sediment goal feasibility (index); assigning a numeric score of 0 to 10 for a risk category for a resource phosphorous goal (index); assigning a numeric score of 0 to 10 for a method to achieve category for a phosphorous goal feasibility (index); assigning a numeric score of 0 to 10 for a category method for a 4r nitrogen fertilizer index; assigning a numeric score of 0 to 10 for a category method for a 4r phosphorous fertilizer index; then averaging all the indices to derive a range of agriculture for the agriculture operation.

According to this disclosure, an embodiment for a method to derive a Weighted Field Stewardship Rating (“WFSR”) as a single number with a value ranging from 0 to 10 for a farm field comprises the determination of the indices in the following manner: calculating a soil water erosion benchmark index; calculating a soil water erosion departure index for agriculture; calculating a soil retention benchmark index; calculating a infiltration benchmark index; calculating a runoff departure index for agriculture; calculating a total phosphorous mobilization index for agriculture; calculating a total phosphorous export index for agriculture; calculating a total phosphorous export departure index for agriculture; calculating a total phosphorous retention benchmark index; assigning a numeric score of 0 to 10 for a risk category for a resource sediment goal (index); assigning a numeric score of 0 to 10 for a method to achieve category for a sediment goal feasibility (index); assigning a numeric score of 0 to 10 for a risk category for a resource phosphorous goal (index); assigning a numeric score of 0 to 10 for a method to achieve category for a phosphorous goal feasibility (index); assigning a numeric score of 0 to 10 for a category method for a 4r nitrogen fertilizer index; assigning a numeric score of 0 to 10 for a category method for a 4r phosphorous fertilizer index; assigning a reliability-weight of 1, 2, or 3 to each of the indices; adjusting the indices based on their reliability-weight, wherein the indices with the reliability-weight of 1 are multiplied by ⅓, the indices with the reliability-weight of 2 are multiplied by ⅔, and the indices with the reliability-weight of 3 are multiplied by 1; then averaging all the indices to derive a range of agriculture for the agriculture operation.

According to this disclosure, an embodiment for a method to derive a Weighted Field Stewardship Rating (“WFSR”) as a single number with a value ranging from 0 to 10 for an irrigated farm field comprises the determination of the indices in the following manner: calculating an irrigation water use efficiency benchmark index; calculating a soil water erosion benchmark index; calculating a soil water erosion departure index for agriculture; calculating a soil retention benchmark index; calculating a infiltration benchmark index; calculating a runoff departure index for agriculture; calculating a total phosphorous mobilization index for agriculture; calculating a total phosphorous export index for agriculture; calculating a total phosphorous export departure index for agriculture; calculating a total phosphorous retention benchmark index; assigning a numeric score of 0 to 10 for a risk category for a resource sediment goal (index); assigning a numeric score of 0 to 10 for a method to achieve category for a sediment goal feasibility (index); assigning a numeric score of 0 to 10 for a risk category for a resource phosphorous goal (index); assigning a numeric score of 0 to 10 for a method to achieve category for a phosphorous goal feasibility (index); assigning a numeric score of 0 to 10 for a category method for a 4r nitrogen fertilizer index; assigning a numeric score of 0 to 10 for a category method for a 4r phosphorous fertilizer index; assigning a reliability-weight of 1, 2, or 3 to each of the indices; adjusting the indices based on their reliability-weight, wherein the indices with the reliability-weight of 1 are multiplied by ⅓, the indices with the reliability-weight of 2 are multiplied by ⅔, and the indices with the reliability-weight of 3 are multiplied by 1; then averaging all the indices to derive a range of agriculture for the agriculture operation.

In another embodiment of the present disclosure, a method to derive an FSR as a single number with a value ranging from 0 to 10 for an agriculture operation comprises the averaging of at least two FSRs. Where the steps of a previous embodiment, that derive a FSR for a farm field, are repeated for each farm field in a farming operation. The FSRs for each farm field are then combined to obtain an FSR for the farming operation.

In another embodiment of the present disclosure, a method to derive an FSR as a single number with a value ranging from 0 to 10 for an agriculture operation comprises the averaging of at least two FSRs. The FSRs may be obtained from farm fields that include irrigated farm fields. Where the steps of a previous embodiment, that derive a FSR for an irrigated farm field, are repeated for each irrigated farm field in a farming operation. The FSRs for each irrigated farm field are then combined to obtain an FSR for the farming operation.

In a further embodiment of the present disclosure, a method to derive a WFSR as a single number with a value ranging from 0 to 10 for an agriculture operation comprises the averaging of at least two WFSRs. Where the steps of a previous embodiment, that derive a WFSR for a farm field, are repeated for each farm field in a farming operation. The WFSRs for each farm field may then be combined to obtain a WFSR for the farming operation.

In a further embodiment of the present disclosure, a method to derive a WFSR as a single number with a value ranging from 0 to 10 for a farming operation comprises the averaging of at least two WFSRs. Where the steps of a previous embodiment, that derive a WFSR for an irrigated farm field, are repeated for each irrigated farm field in a farming operation. The WFSRs for each irrigated farm field are then combined to obtain a WFSR for the farming operation.

An embodiment of the present disclosure is a method of using an FSR. This embodiment may first start with deriving of a FSR as a single number with a value ranging from 0 to 10 for a farm field comprises the determination of indices in the following manner: calculating a soil water erosion benchmark index; calculating a soil water erosion departure index for agriculture; calculating a soil retention benchmark index; calculating a infiltration benchmark index; calculating a runoff departure index for agriculture; calculating a total phosphorous mobilization index for agriculture; calculating a total phosphorous export index for agriculture; calculating a total phosphorous export departure index for agriculture; calculating a total phosphorous retention benchmark index; assigning a numeric score of 0 to 10, for a risk category for a resource sediment goal (index); assigning a numeric score of 0 to 10, for a method to achieve category for a sediment goal feasibility (index); assigning a numeric score of 0 to 10, for a risk category for a resource phosphorous goal (index); assigning a numeric score of 0 to 10, for a method to achieve category for a phosphorous goal feasibility (index); assigning a numeric score of 0 to 10, for a category method for a 4r nitrogen fertilizer index; assigning a numeric score of 0 to 10, for a category method for a 4r phosphorous fertilizer index; then averaging all the indices to derive a range of agriculture for the agriculture operation. A benchmark of a current agriculture operation may be provided, and then taking that benchmark so a conceptualization of methods to improve the FSR may be used in turn to improve the agriculture operation; then, the improvements may be implemented with the methods that were conceptualized to achieve the improvements. These improvements may then be used in the branding of the agriculture operation, which in turn may allow the agriculture producer to enhance the commercialization of their agriculture products.

The method of using an FSR can include the additional steps of calculating an irrigation water use efficiency benchmark index for an irrigated farm field, which then may be added to the irrigation water use efficiency benchmark index to the total of all the indices.

The method of using an FSR can include the additional steps of assigning a reliability weight of 1, 2, or 3 to each of the indices. And then, the adjusting of the indices scores may occur based on their reliability-weight, wherein the indices with the reliability-weight of 1 are multiplied by ⅓, the indices with the reliability-weight of 2 are multiplied by ⅔, and the indices with the reliability-weight of 3 are multiplied by 1. Once the indices have been weighted, they may then be calculated as a total for the adjusted; and then the total may be averaged to derive a weighted field stewardship rating for the farm field.

An additional embodiment of the method of using an FSR can include the additional steps of assigning a reliability weight to the irrigation water use efficiency benchmark index. And then, the assigning of a reliability weight of 1, 2, or 3 to each of the indices may occur. Then there may be an adjusting of the indices scores based on their reliability-weight, wherein the indices with the reliability-weight of 1 are multiplied by ⅓, the indices with the reliability-weight of 2 are multiplied by ⅔, and the indices with the reliability-weight of 3 are multiplied by 1. Then there may be a calculation of a total for the adjusted indices with the irrigation water use efficiency benchmark index. Once completed, then there may be an averaging of the total to derive a weighted field stewardship rating for the farm field.

The method of using an FSR can include the additional steps of obtaining index values for at least one other farm field. Once obtained, the index values may then include an averaging of the values for the at least one other farm field, which may derive a field stewardship rating for the at least one other farm field. There may then be a combining of the FSR of the farm field with the FSR of the at least one other farm field, which may then derive a field stewardship rating for a farm or farming operation.

In an additional embodiment of the method of using an FSR can include the additional steps of calculating an irrigation water use efficiency benchmark index for at least one other irrigated farm field. Then there may be a combination of the index values for the at least one other irrigated farm field with the irrigation water use efficiency benchmark index for the at least one other irrigated farm field. Then there may be an averaging of the total of the combined values for the at least one other irrigated farm field with the irrigation water use efficiency benchmark index for the at least one other irrigated farm field, which may then derive a field stewardship rating for the at least one other irrigated farm field. There then may be a combining of the FSR of the irrigated farm field with the FSR of the at least one other irrigated farm field, which may derive an FSR for a farming operation.

In an additional embodiment of the method of using an FSR can include the additional steps of obtaining index values for at least one other farm field. There then may be an assigning of a reliability weight of 1, 2, or 3 to each of the indices for the at least one other farm field. The indices may then include an adjusting of the indices scores of the at least one other farm field based on their reliability-weight, wherein the indices with the reliability-weight of 1 are multiplied by ⅓, the indices with the reliability-weight of 2 are multiplied by ⅔, and the indices with the reliability-weight of 3 are multiplied by 1. There then may be a calculation of a total for the adjusted indices of the at least one other farm field. There then may be an averaging of the total to derive a weighted field stewardship rating for the at least one other farm field. There then may be a combining of the weighted FSR of the farm field with the weighted FSR of the at least one other farm field to derive a weighted FSR for a farming operation.

In an additional embodiment of the method of using an FSR can include the additional steps of obtaining index values for at least one other irrigated farm field. There then may be a calculation of an irrigation water use efficiency benchmark index for the at least one other irrigated farm field. There then may be included in this embodiment an assigning of a reliability-weight of 1, 2, or 3 to each of the indices and the irrigation water use efficiency benchmark index for the at least one other irrigated farm field, wherein the indices with the reliability-weight of 1 are multiplied by ⅓, the indices with the reliability-weight of 2 are multiplied by ⅔, and the indices with the reliability-weight of 3 are multiplied by 1. There then may be a calculating of a total for the adjusted indices in steps a. through o. and the irrigation water use efficiency benchmark index for the at least one other irrigated farm field. There then may be an averaging of the total to derive a weighted field stewardship rating for the at least one other irrigated farm field. This then may be followed by the step of combining the weighted FSR of the irrigated farm field with the weighted FSR of the at least one other irrigated farm field to derive a weighted FSR for a farming operation.

The above summary is not intended to describe each and every example or every implementation of the disclosure. The description that follows more particularly exemplifies various illustrative embodiments

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings.

FIG. 1 is a flow chart overview of implementing an embodiment of the present method.

FIG. 2 is a flow chart overview of implementing an embodiment of the present method.

FIG. 3 is an example of implementing an embodiment of the present method

FIG. 4 is an example of an index utilization of an embodiment of the present method.

FIG. 5 is an example of a PTMApp map of an embodiment of the present method.

FIG. 6 is an example Profit versus Field Stewardship Rating graph of an embodiment of the present method.

FIG. 7 is an example of an interpretation of the indices used to determine a field stewardship rating of an embodiment of the present method.

### DETAILED DESCRIPTION

The present disclosure relates to a field stewardship rating, and more particularly to such Field Stewardship Ratings that rely on multiple, quantitative factors to determine the quality of agricultural stewardship for an agricultural producer. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient. Still, these are intended to cover applications or embodiments without departing from the disclosure's spirit or scope. Also, it is to be understood that the phraseology and terminology used herein are for the purpose of description and should not be regarded as limiting.

A field stewardship rating (“FSR”) is a quantitative representation defined through the use of quantitative and semi-quantitative indices. The FSR reflects the quality of agricultural stewardship for an agricultural operation, which may consist of a farm field, a farm with multiple farm fields, or a farming operation, where the farming operation can consist of multiple farms or a combination of farms and farm fields. Therefore, the FSR may be used to characterize certain aspects of agricultural sustainability and is represented by a single number with a value ranging from 0 to 10. Specifically, the FSR describes the relationship between the methods used by an agricultural producer to farm a field, stewardship quality, and water and soil-related indices used to describe agricultural sustainability. The change in the FSR resulting from a change in an agricultural producer's operation quantifies specific resource outcomes, including soil mobilization and transport, the amount of surface water runoff and water quality, nutrient mobilization and export, and impacts on downstream water bodies. A single FSR for a farm field, or irrigated farm field, may be combined with other FSRs for either type of field in a single agriculture operation to derive an FSR that represents the agriculture operation as a whole.

The FSR is a scalable solution to assist producers with profitability in their agriculture operations, ideally throughout the agriculture supply and delivery chain. Therefore, the FSR focuses first on profit and then exploring the relationship between stewardship quality and environmental outcomes. Finding a positive relationship between profit and stewardship quality may mean less need for government conservation incentives. The FSR will assist in directing agriculture operational changes to increase net profit while simultaneously increasing stewardship quality (for example, by positively affecting water quality and runoff).

The FSR is determined for a specific farm field and is a function of the (a) physical characteristics of the field (e.g., soil type, land slope); (b) type of crops planted; (c) methods used to till the soil; (d) use of conservation practices; and (e) residue amount on the soil surface. Combing the FSR values for several farm fields characterizes the stewardship quality and agricultural sustainability of a farm (comprised of several fields) and the agricultural producer.

The FSR reflects the influence of the agriculture operation on soil mobilization, soil retained within the field boundary after mobilization, water retention by the soil profile, and the risk to downstream water resources from sediment and phosphorus leaving the field. To calculate an FSR, indices are derived with the use of the following five broad categories: (1) benchmarking the stewardship quality and agricultural sustainability of the producer's current operation; (2) conceptualizing and implementing methods to improve stewardship quality and agricultural sustainability (i.e., continuous improvement); (3) brand the stewardship quality and agricultural sustainability of the producer's operation for a field, for multiple fields comprising one or more farms, and the agricultural producer; (4) estimating environmental outcomes at the subfield, field, and watershed scales; and (5) developing strategies to improve water management and water quality.

The indices may be weighted based on the scientific quality of the data used to generate their value. Each index may be assigned one of three reliability weights of either high, moderate, or low. A high reliability weight goes to an index that is not based on an opinion; it is well supported by scientific and research data; also, a benchmark value is known for the index. A moderate reliability weight goes to an index that is based on some opinion from an expert and includes a moderate to limited amount of scientific and research data; the benchmark value for a moderate-reliable index is also based on a moderate to limited amount of scientific and research data. A low reliability weight goes to an index that is based primarily on an opinion; an expert's Best Professional Judgment determines the index based on a limited amount of scientific and research data; also, the benchmark value for a Low-reliable index is based on a limited amount of scientific and research data.

### Indices

From the five broad categories, multiple quantitative and semi-quantitative indices are used to create a single FSR rating. Indices that deal with agricultural operations assume that a field for which an FSR is being quantified remains in agricultural production; i.e., they are not allowed to lay fallow. The five broad categories include Benchmark Indices, Agricultural Operation Indices, Agricultural Operation Departure Indices, Performance Indices, and Regulatory Risk Indices. Agriculture production can range from a producer's current farming operation, which includes crop rotation, fertilization methods, and tillage methods, to a producer only planting a crop for forage. The indices are defined in the following manner.

Range for agriculture. The range for agriculture is a particular estimation defined for each of the indices as described below, where the range of agriculture is the denominator of the percent calculation. The range for agriculture can be defined as the range in the level of activity for a field, with the assumption that the field remains in agricultural production; i.e., the field is not allowed to lay fallow.

A maximum endpoint for the range can be defined as an operation where a producer uses a field in a continuation of their current operation, where the operation includes crop rotation and fertilizer methods, and may also include moldboard plowing as the tillage method. In other words, the field is being used to the maximum of its intensity. The minimum endpoint of the range can be defined as an operation where a producer uses the field to at least include a planting with alfalfa, either for forage production or as a cash crop. The minimum of the range represents the least intensive method for a field in agriculture production; allowing the field to lie fallow would skew the range to an unacceptable minimum and not allow the creation of an FSR that would be useful to determine a producer's agricultural stewardship for their operation.

One version of the range of agriculture is determined from the rate of soil movement (in tons/acre/year) from water sheet and rill erosion. The maximum range endpoint, in this determination, represents a model estimation of the rate of soil movement when the producer continues their current operation (crops grown, fertilizer methods used) and where moldboard plowing is the tillage method. The minimum range endpoint represents a measurement of the rate of soil movement of the same field when the producer is growing alfalfa, either for forage, or as a cash crop. The range of agriculture is used as part of the calculation for many of the following indices, as noted below.

Another version of the range of agriculture can be calculated with an infiltration amount (in inches/year and acre-feet/year), the amount of water infiltrating into the soil profile, and a “typical” infiltration amount for the field. The “typical” amount of infiltration is based on a precipitation amount for a 2-year return period rainfall (approximately 2.4 inches) occurring over a 24-hour time period to represent the long-term median condition. This range's endpoints are determined using the same field uses as the range derived from the rate of soil movement, where at a minimum, the infiltration amount is measured when the producer continues their current operation (crops grown, fertilizer methods used), and where moldboard plowing is the tillage method, and where at a maximum the infiltration amount of the same field is measured when the producer is growing alfalfa; either for forage, or as a cash crop; the range is the difference between the two endpoints.

A further range of agriculture may also be determined by the amount of surface water runoff (in inches/year and acre-feet/year), where the amount of runoff is determined from the amounts of precipitation falling on the field surface and irrigation water applied for a significant period of time, for example, a five year period. Other periods of time may be required to generate the data; the intent is to reflect the long-term operation of the producer's field, farm, or farm operation. It may be more useful to have six years of data that may include a representation of a five-year crop rotation. However, long-term data is not a necessity, a shorter period of time, even as little as one year, may be used in this calculation. This range's endpoints are determined using the same field uses as the range derived from the rate of soil movement, where at a maximum, the surface water runoff is measured when the producer continues their current operation (crops grown, fertilizer methods used), and where moldboard plowing is the tillage method, and where at a minimum the surface water runoff of the same field is measured when the producer is growing alfalfa; either for forage, or as a cash crop.

### Benchmark Indices

Conceptually, the benchmark index compares a field's quantitative value to some “desired” level. An example is the soil formation rate benchmark index, where the estimated field soil loss rate is compared to the rate soil forms. A benchmark index is a simple ratio between the benchmark value and the field quantitative value. A larger value is more desired.

Soil Water Erosion Benchmark Index (“SoWaErBeIn”); this benchmark index calculates the rate soil is moved by precipitation, impacting the field surface and causing water sheet and rill erosion compared to the rate soil forms. An index value exceeding one means soil is moved at a greater rate than formed. An index value less than one means soil is forming more rapidly than being moved and rebuilding the soil profile. This index is classified with a Low reliability weight. The reference values used for this benchmark index come from the soil formation rate, which typically has values ranging from 0.16 to 0.57 tons/acre/year (Toshiyuki Wakatsuki, Azwar Rasyidin, Rates of weathering and soil formation, Geoderma 251-263 (1992).

The rate soil moves can be estimated using several commonly available tools and models. Examples of currently available tools and models include the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), the Universal Soil Loss Equation (USLE) (https://efotg.sc.egov.usda.gov/references/public/IA/Universal_Soil_Loss_Equation1.pdf) and its descendants the Revised Universal Soil Loss Equation (RULSE2) (https://fargo.nserl.purdue.edu/rusle2_dataweb/RUSLE2_Index.htm) and the Water Erosion Prediction Project (WEPP) (https://data.nal.usda.gov/system/files/wepp_usersum.pdf). The USLE is the model currently used for deriving the index.

The SoWaErBeIn is calculated by dividing the rate of soil movement from water sheet and rill erosion by the soil formation rate, as illustrated in the following equation.

$$SoWaErBeIn = \frac{rate of soil movement from water sheet and rill erosion}{soil formation rate}$$

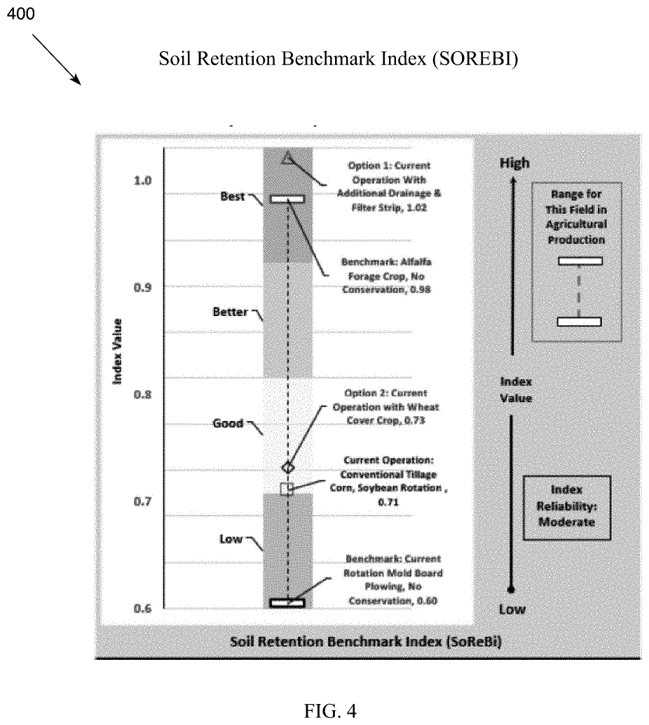

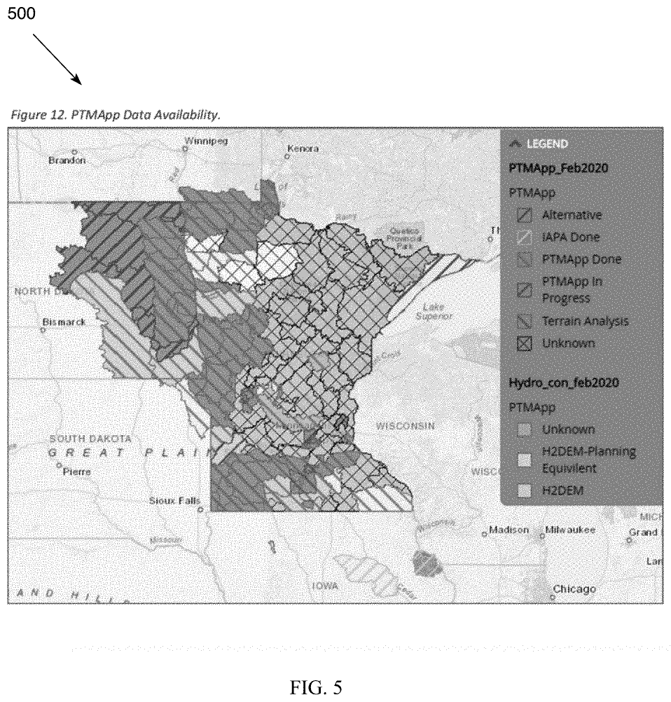

Soil Retention Benchmark Index (“SoReBeIn”); this index represents the reduction in the amount of soil moved by precipitation impacting the field surface and the amount trapped by agricultural conservation practices before leaving the field compared to the field planted to a corn-soybean rotation tilled using a moldboard plow tillage system. This index is classified with a high reliability weight. The reference values used for this benchmark index come from the amount of soil mobilized by sheet and rill erosion and trapped by existing conservation practices for the same crop but in a moldboard tillage system. The amount of soil trapped by conservation practices can be estimated using multiple methods, including using values from the scientific literature and using the same commonly available tools and models as described in the Soil Water Erosion Benchmark Index. The Prioritize, Target, and Measure Application (PTMApp) (https://bwsr.state.mn.us/ptmapp) is currently used to estimate the amount of soil trapped by conservation measures; an example PTMApp map 500 is illustrated in FIG. 5. The utilization of this data can be presented in a graphic 400 to assist a producer in improving their index score as illustrated in FIG. 4.

The SoReBeIn index values are positive; larger index values mean a larger portion of the soil moved by water sheet, and rill erosion is trapped by conservation practices before leaving the field; see the following equation.

$$SoReBeIn = \frac{\begin{matrix}amount of soil leaving the \\ field due to sheet and rill erosion\end{matrix}}{\begin{matrix}amount of soil leaving the field corn - \\ soybean rotation moldboard plow tillage system\end{matrix}} \times 100$$

Infiltration Benchmark Index (“InBeIn”); this index calculates the proportion of the amount of water that enters the soil profile compared to the amount of precipitation falling on and irrigation water applied to the field. This index is classified with a moderate reliability weight. The reference values used for this benchmark index come from the amounts of precipitation falling on the field and irrigation water that are measured over a five-year period, with the units being represented as inches/year and acre-feet.

The InBeIn index values are positive; larger index values mean a larger portion of the precipitation and irrigation water enters the soil profile. Amounts of precipitation falling on the field and irrigation water applied are measured over a five-year period and use units that are inches/year and acre-feet; see the following equation.

$$InBeIn = \frac{amount water infiltrating into the soil profile}{amount of precipitation and irrigation water applied} \times 100$$

Runoff Benchmark Index(“RuBeIn”); this index calculates the proportion of precipitation falling on and irrigation water applied to the field that leaves as surface water runoff. This index is classified with a moderate reliability weight. Typically the estimates are derived from using several commonly available tools and models; e.g., the annual amount of precipitation infiltrating into the soil profile and leaving the field as surface water runoff can be estimated using the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), and the curve number method. The method currently used is a curve number-based method following the approach of Mishra, S., Jain, M. & Singh, V. Evaluation of the SCS-CN-Based Model Incorporating Antecedent Moisture. Water Resour Manage 18, 567-589 (2004). The amount of irrigation water applied is provided from actual irrigation records.

The RuBeIn index values are positive; larger index values mean a larger portion of the precipitation and irrigation water leaves the field as surface water runoff. The reference values used for this benchmark index come from the amount of precipitation falling on the field surface and irrigation water applied for a five-year period. Units are inches/year and acre-feet; see the following equation.

$$RuBeIn = \frac{amount surface water runoff}{amount of precipitation and irrigation water applied} \times 100$$

Irrigation Water Use Efficiency Benchmark Index (“IrrUseEffBeIn”); this index calculates the change in the amount of infiltration compared to the amount of irrigation water applied to the field. This index is classified with a moderate reliability weight. The annual amount of precipitation infiltrating into the soil profile and leaving the field as surface water runoff is estimated. Typically the estimates are derived from using several commonly available tools and models; e.g., the annual amount of precipitation infiltrating into the soil profile and leaving the field as surface water runoff can be estimated using the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), and the curve number method. The method currently used is a curve number-based method following the approach of Mishra, S., Jain, M. & Singh, V. Evaluation of the SCS-CN-Based Model Incorporating Antecedent Moisture. Water Resour Manage 18, 567-589 (2004). The amount of irrigation water applied is provided from actual irrigation records.

The IrrUseEffBeIn index is the difference between the infiltration amount for irrigated and non-irrigated conditions as a proportion of the amount of irrigation water applied to the field. Index values are positive; larger index values mean a larger portion of the irrigation water applied enters the soil horizon and is potentially used by crops. This index is typically used for fields that are irrigated. The reference values used for this benchmark index come from the amounts of irrigation water applied for a five-year period. Units are inches/year and acre-feet; see the following equation.

$$IrrUseEffBeIn = \frac{change in infiltration amount}{amount of irrigation water applied} \times 100$$

Total P Retention Benchmark Index (“TPReBeIn”); this index calculates the percent of the total phosphorus mobilization by surface water runoff and soil movement and trapped by agricultural conservation practices before leaving the field compared to planting the same crops but tillage using a moldboard plow system. This index is classified with a moderate reliability weight.

The amount of total phosphorus trapped by conservation practices can be estimated using multiple methods, including using values from the scientific literature and models. For example, the Prioritize, Target, and Measure Application (PTMApp) (https://bwsr.state.mn.us/ptmapp). The reference values used for this benchmark index come from the amount of total phosphorus trapped by conservation practices. An example PTMApp map 500 is illustrated in FIG. 5.

The TPReBeIn index values are positive; larger index values mean a larger portion of the total phosphorus mobilized by surface water runoff, and soil movement is trapped by conservation practices before leaving the field; see the following equation.

$$TPReBeIn = \frac{amount of total phosphorus leaving the field}{\begin{matrix}amount of total phosphorus leaving the field for a corn - \\ soybean rotation moldboard plow tillage system\end{matrix}} \times 100$$

### Agricultural Operation Indices

The agriculture operation index compares a field's quantitative value to a probable (quantitative) range for the field in agricultural production. The range for agriculture is intended to represent the “bookends” for the field in agricultural production. Alfalfa forage and the farmer's current rotation assuming a moldboard tillage system, were used to reflect the bookends. The agriculture operational index essentially represents what the “percentile” is for the current operation relative to the agricultural range. The field quantitative value is normalized (divided by) the range for agriculture. A low ratio is less desirable than a high percentage.

Soil Water Erosion Index for Agriculture (“SoWaErInAg”); this index expresses the rate soil is moved by precipitation impacting a field's surface as a percentage of the range for agriculture. The rate of soil movement for the field is “normalized” by the range for agriculture. This index is classified with a low reliability weight. The SoWaErInAg is estimated using the same commonly available tools and models as described in the Soil Water Erosion Benchmark Index.

The rate soil moves can be estimated using several commonly available tools and models. These include the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), the Universal Soil Loss Equation (USLE) (https://efotg.sc.egov.usda.gov/references/public/IA/Universal_Soil_Loss Equation1.pdf) and its descendants the Revised Universal Soil Loss Equation (RULSE2) (https://fargo.nserl.purdue.edu/rusle2_dataweb/RUSLE2_Index.htm) and the Water Erosion Prediction Project (WEPP) (https://data.nal.usda.gov/system/files/wepp_usersum.pdf). The USLE is the model currently used for deriving the index.

The range for agriculture references value used for this agriculture operation index comes from the rate of soil movement (in tons/acre/year) from water sheet and rill erosion for the producer's current operation (crops grown, fertilizer methods used) and growing alfalfa for forage or as a cash crop.

The SoWaErInAg index values are positive; lower values mean the rate soil is moved/mobilized is a smaller percentage of the range for agriculture, and larger values mean the rate soil is moved/mobilized is a larger percentage of the range for agriculture; see the following equation.

$$SoWaErInAg = \frac{rate of soil movement from water sheet and rill erosion}{range for agriculture} \times 100$$

Total P Mobilization Index for Agriculture (“TPMobInAg”); this index expresses the rate of total phosphorus mobilization by surface water runoff and soil movement as a percentage of the range for agriculture. This index is classified with a moderate reliability weight.

The rate of total phosphorus mobilization is estimated using a yield coefficient (lb/ac/yr) from the scientific literature as referenced in the Prioritize, Target, and Measure Application (PTMApp) documentation. The rate of mobilization for a specific field is adjusted based on the proportion of the total phosphorus transported as dissolved within surface water runoff and attached to soil particles (using Best Professional Judgement).

The range for agriculture reference value used for this agriculture operation index is determined from the rate of soil movement (in lbs/acre/year) from water sheet and rill erosion for the producer's current operation (crops grown, fertilizer methods used) and growing alfalfa for forage or as a cash crop.

The total phosphorus mobilization rate is “normalized” by the range for agriculture. The TPMobInAg index values are positive; lower values mean the total P mobilization rate is a smaller percentage of the range for agriculture, and higher values mean the total P mobilization rate is a larger percentage of the range for agriculture; see the following equation.

$$TPMobINAg = \frac{\begin{matrix}rate of total phosphorus mobilization by surface water \\ runoff and soil movement\end{matrix}}{range for agriculture} \times 100$$

Total P Export Index for Agriculture (“TPExInAg”); this index expresses the rate of total phosphorus export from a field by surface water runoff and soil movement as a percentage of the range for agriculture. This index is classified with a moderate reliability weight.

The rate of total phosphorus export is the product of the rate of total phosphorus mobilization (estimated in the same way as same as the Total P Mobilization Index for Agriculture) and a delivery percentage. The delivery percentage reflects the proportion of the total phosphorus mobilized that reaches the edge of field and is estimated using the value from the Prioritize, Target, and Measure Application (PTMApp).

The range for agriculture references value used for this agriculture operation index is determined from the rate of soil movement (in lbs/acre/year) from water sheet and rill erosion for the producer's current operation (crops grown, fertilizer methods used) and growing alfalfa for forage or as a cash crop.

The TPExInAg is “normalized” by the range for agriculture, and its index values are positive; lower values mean the total P export rate is a smaller percentage of the range for agriculture, and higher values mean the total P export n rate is a larger percentage of the range for agriculture; see the following equation.

$$TPExInAg = \frac{\begin{matrix}rate of total phosphorus export from the field by \\ surface water runoff and soil movement\end{matrix}}{range for agriculture} \times 100$$

### Agricultural Operation Departure Indices

The agriculture operation departure index. The agriculture operation departure index compares a field quantitative value to the midpoint value of the probable range for the field in agricultural production normalized by the probable range for the field in agricultural production. The raw index value is negative if less than and positive if greater than the midpoint value for the agricultural range. The amount of departure from the midpoint is normalized by the agricultural range. In a statistical sense, the agricultural operation departure index represents the departure from a mean or median value.

Soil Formation Departure Index for Agriculture (“SoFoDeInAg”); this index is represented as a percentage and calculates the difference between the rate soil is removed by precipitation impacting the field's surface and the rate that soil forms in a field that is in agricultural production (not allowed to lie fallow). The difference in the rates is “normalized” by the range for agriculture. This index is classified with a low reliability weight. The SoFoDeInAg is estimated using the same commonly available tools and models as described in the Soil Water Erosion Benchmark Index.

The rate soil moves can be estimated using several commonly available tools and models. These include the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), the Universal Soil Loss Equation (USLE) (https://efotg.sc.egov.usda.gov/references/public/IA/Universal_Soil_Loss _Equation1.pdf) and its descendants the Revised Universal Soil Loss Equation (RULSE2) (https://fargo.nserl.purdue.edu/rusle2_dataweb/RUSLE2_Index.htm) and the Water Erosion Prediction Project (WEPP) (https://data.nal.usda.gov/system/files/wepp_usersum.pdf). The USLE is the model currently used for deriving the index.

The range for agriculture references value used for this agriculture operation departure index is derived from the rate of soil movement (in tons/acre/year) from water sheet and rill erosion for the producer's current operation (crops grown, fertilizer methods used) and growing alfalfa for forage or as a cash crop.

An index value equal to zero means the rate of soil movement from water sheet and rill erosion is equal to the soil formation rate. An index value greater than zero means the rate of soil movement exceeds the formation rate. An index value less than zero means the rate of soil movement is less than the formation rate for the field in agricultural production; see the following equation.

$$SoFoDeInAg = \frac{\begin{matrix}rate of soil movement from water sheet and rill erosion - \\ soil formation rate\end{matrix}}{range for agriculture} \times 100$$

Soil Water Erosion Departure Index for Agriculture (“SoWaErDeInAg”); this index represents the percent difference between the rate soil is moved by precipitation impacting a field's surface compared to a “typical” value for agriculture. The difference between the rate soil is moved, and the average rate for the agriculture range is “normalized” by the range for agriculture. This index is classified with a high reliability weight. The SoWaErDeInAg is estimated using the same commonly available tools and models as described in the Soil Water Erosion Benchmark Index.

The range for agriculture references value used for this agriculture operation departure index is derived from the rate of soil movement (in tons/acre/year) from water sheet and rill erosion for the producer's current operation (crops grown, fertilizer methods used) and growing alfalfa for forage or as a cash crop.

An SoWaErDeInAg index value greater than zero means soil movement exceeds a “typical value” (i.e., the average) for the field in agricultural production. An index value less than zero means soil movement is less than a “typical value” for the field in agricultural production; see the following equation.

$$SoWaErDeInAg = \frac{\begin{matrix}rate of soil movement from water sheet and rill erosion - \\ average rate for agriculture range\end{matrix}}{range for agriculture} \times 100$$

Infiltration Departure Index for Agriculture (“InDeInAg”); this index represents the percent difference between the amount of water infiltrating into the soil profile and a “typical” infiltration amount of the range for agriculture. The difference between the infiltration amount for the field and the average amount is “normalized” by the range for agriculture. This index is classified with a moderate reliability weight.

The amount of precipitation infiltrating into the soil profile and leaving the field as surface water runoff annually can be estimated using several commonly available tools and models. These include the Soil and Water Assessment Tool (SWAT) (https://swat.tamu.edu/), Hydrologic Simulation Program Fortran (HSPF) (https://www.epa.gov/ceam/hydrological-simulation-program-fortran-hspf), Environmental Policy Integrated Climate Model (EPIC), Agricultural Policy Climate Extender Model (APEX) (https://epicapex.tamu.edu/), and the curve number method.

The method currently used is a curve number-based method following the approach of Mishra, S., Jain, M. & Singh, V. Evaluation of the SCS-CN-Based Model Incorporating Antecedent Moisture. Water Resour Manage 18, 567-589 (2004). The amount of irrigation water applied is provided from actual irrigation records for the field.

The range for agriculture references value used for this agriculture operation departure index is derived from the infiltration amount (in inches/year and acre-feet/year) for the producer's current operation except tillage using a board plow and growing alfalfa for forage or as a cash crop.

An InDeInAg index value greater than zero means the infiltration amount exceeds a “typical value” for a field in agricultural production, and an index value less than zero means the infiltration amount is less than a “typical value” for a field in agricultural production; see the following equation.

$$InDeInAg = \frac{infiltration amount - average amount for agriculture range}{range for agriculture} \times 100$$

Runoff Departure Index for Agriculture (“RuDeInAg”); this index represents the percent difference between the amount of water leaving a field as surface water runoff and a “typical” amount for the agriculture range. The difference between the surface water runoff amount for a field and the average amount for agriculture is “normalized” by the range for agriculture. This index is classified with a moderate reliability weight.

The annual amount of precipitation infiltrating into the soil profile and leaving the field as surface water runoff is estimated using the same methods as those used for the Infiltration Departure Index for Agriculture.

The range for agriculture references value used for this agriculture operation departure index is derived from the amount of surface water runoff (in inches/year and acre-feet/year) for the producer's current operation except tillage using a board plow and growing alfalfa for forage or as a cash crop.

An RuDeInAg index value greater than zero means the amount of surface water runoff exceeds a “typical value” for the field in agricultural production, and an index value less than zero means the amount of surface water runoff is less than a “typical value” for the field in agricultural production; see the following equation.

$$RuDeInAg = \frac{runoff amount - average runoff amount for agriculture range}{range for agriculture} \times 100$$

Total P Mobilization Departure Index for Agriculture (“TPMobDeInAg”); this index represents the percent difference between the mobilization rate by surface water runoff and soil movement and the average rate for agriculture, as a percentage of the range for agriculture. The difference between the rate of total phosphorus is mobilized by surface water runoff and soil movement, and the average rate for agriculture is “normalized” by the range for agriculture. This index is classified with a moderate reliability weight.

The rate of total phosphorus departure mobilization is estimated using a yield coefficient (lbs/acre/year) from the scientific literature as referenced in the Prioritize, Target, and Measure Application (PTMApp) documentation. The rate of mobilization for a specific field is adjusted based on the proportion of the total phosphorus transported as dissolved within surface water runoff and attached to soil particles (using Best Professional Judgement).

The range for agriculture references value used for this agriculture operation departure index is derived from the rate of soil movement (in lbs./acre /year) from water sheet and rill erosion for the producer's current operation (crops grown, fertilizer methods used) and growing alfalfa for forage or as a cash crop.

A TPMobDeInAg index value greater than zero means the amount of total phosphorus mobilization rate exceeds a “typical value” for the field in agricultural production, and a TPMobDeInAg index value less than zero means the total phosphorus mobilization rate is less than a “typical value” for the field in agricultural production; see the following equation.

$$TPMobDeInAg = \frac{\begin{matrix}rate of total phosphorus mobilization by surface water runoff \\ and soil movement - average rate for agriculture range\end{matrix}}{range for agriculture} \times 100$$

Total P Export Departure Index for Agriculture (“TPExDeInAg”); this index represents the percent difference between the total phosphorus export rate from the field by surface water runoff and soil movement and the average rate for agriculture, as a percentage of the range for agriculture. The difference in the rate of total phosphorus is exported by surface water runoff and soil movement, and the average rate for agriculture is “normalized” by the range for agriculture. This index is classified with a moderate reliability weight.

The rate of total phosphorus export departure is the product of the rate of total phosphorus mobilization (estimated in the same way as same as the Total P Mobilization Index for Agriculture) and a delivery percentage. The delivery percentage reflects the proportion of the total phosphorus mobilized that reaches the edge of field and is estimated using the value from the Prioritize, Target, and Measure Application (PTMApp).

The range for agriculture references value used for this agriculture operation departure index is derived from the rate of soil movement (in lbs./acre/year) from water sheet and rill erosion for the producer's current operation (crops grown, fertilizer methods used) and growing alfalfa for forage or as a cash crop.

A TPExDeInAg index value greater than zero means the amount of export rate exceeds a “typical value” for the field in agricultural production. An TPExDeInAg index value less than zero means the export rate is less than a “typical value” for the field in agricultural production; see the following equation.

$$TPExDeInAg = \frac{\begin{matrix}rate of total phosphorus export by surface water runoff and \\ \begin{matrix}soil movement from field - \\ average export rate for agriculture range\end{matrix}\end{matrix}}{export range for agriculture} \times 100$$

### Performance Indices

The performance indices reflect whether the farmer uses specific industry standards. The fertilizer management indices are examples of a performance index, where the fertilizer management methods are compared to the right source, right rate, right time, and right place (4R) standards. The advanced 4R category received the higher value and is most desirable.

4R Nitrogen Fertilizer Index (“NFertIn”); this performance index reflects how the agricultural producer applies nitrogen fertilizer, specifically the source, rate, timing, and placement of the fertilizer. The fertilizer source, application rate, application timing, and placement (i.e., Categories) are classified as “Less than Basic,” “Basic,” “Intermediate,” or “Advanced/Emerging” by comparing the methods used by the agricultural producer to specific industry recommendations. The recommendations from Snyder are used as the criteria for Nitrogen fertilizer (C. S. Snyder, Suites of 4R Nitrogen Management Practices for Sustainable Crop Production and Environmental Protection, International Plant Nutrition Institute (1) 1-16 (2016)). The NFertIn performance index is classified with a high reliability weight.

The methods used by the agricultural producer to fertilize their field with nitrogen and phosphorus are compared to the criteria for each category (i.e., the source, rate, timing, and placement). A pass/fail value is assigned to each criterion within each category. All criteria within a category must “pass” to be considered Basic, Intermediate, or Advanced/Emerging. Less than Basic means a failure to satisfy all of the basic criteria. The criteria within each category are converted to a numeric value as follows:
½ or fewer of the Basic criteria realized score for category assigned=0
More than ½ of the Basic criteria realized but not all scores for category assigned=2.5
All Basic criteria realized score for category assigned=5
All Basic and at least one intermediate criteria=6.25
All Intermediate criteria realized score for category assigned=7.5
All Advanced/Emerging criteria realized score for category assigned=10
   The numerical value for source, rate, timing, and placement are averaged to attain the final NFertIn.

4R Phosphorus Fertilizer Index (“PFertIn”); this performance index reflects how the agricultural producer applies phosphorus fertilizer, specifically the source, rate, timing, and placement of the fertilizer. The fertilizer source, application rate, application timing, and placement (i.e., Categories) are classified as “Less than Basic,” “Basic,” “Intermediate,” or “Advanced/Emerging” by comparing the methods used by the agricultural producer to specific industry recommendations. The PFertIn performance index is classified with a high reliability weight.

The methods used by the agricultural producer to fertilize their field with nitrogen and phosphorus are compared to the criteria for each category (i.e., the source, rate, timing, and placement). A pass/fail value is assigned to each criterion within each category. All criteria within a category must “pass” to be considered Basic, Intermediate, or Advanced/Emerging. Less than Basic means a failure to satisfy all of the basic criteria.

The criteria for phosphorus fertilizer is derived from the recommendations in 4R Phosphorus Management Practices for Major Commodity Crops of North America (Bruulsema, International Plant Nutrition Institute, March 2017, Ref #17023).
½ or fewer of the Basic criteria realized score for category assigned=0
More than ½ of the Basic criteria realized but not all scores for category assigned =2.5
All Basic criteria realized score for category assigned=5
All Basic and at least one intermediate criteria=6.25
All Intermediate criteria realized score for category assigned=7.5
All Advanced/Emerging criteria realized score for category assigned=10
   The numerical value for source, rate, timing, and placement are averaged to attain the final PFertIn.

### Regulatory Risk Indices

The regulatory risk indices represent the regulatory risk to an agricultural producer, or the risk of their operation being scrutinized, based on the potential adverse impact to downstream lakes, reservoirs, streams, rivers, or other water bodies due to the production of sediment from eroded soil leaving a producer's field and then reaching a waterbody

Resource Sediment Goal Index (“ReSedGlIn”); this index represents the regulatory risk to the agricultural producer (or risk their operation is scrutinized) based on the potential adverse impact to downstream lakes, reservoirs, streams, rivers, or other water bodies because of the amount of sediment (from eroded soil) leaving the producer's field and reaching the water body. This ReSedGlIn index is classified with a moderate reliability weight.

The method used to estimate the amount of sediment reaching the edge of field and being transported downstream to a specific lake or river is based on the methods within the Prioritize, Target, and Measure Application (PTMApp). This method is a combination of the methods described in the Soil Water Erosion Benchmark Index and the Soil Retention Benchmark Index.

A risk category is assigned to the field based on whether the sediment load (tons/year) leaving the field exceeds a “probable desired target” or “allowable limit” (i.e., allowed amount) for the year from the field. The field allowable amount is derived from the amount established by some entity to protect, maintain, improve or restore the water quality of the downstream water body (i.e., “target load”).

The risk category is converted into the index value by assigning a numeric score to the category, as shown in the following table.

| Percent Load from | | Numeric |
|---|---|---|
| Field Exceeds Goal | | Score |
| Amount Leaving Field | Risk Category | Assigned |
| Does not exceed | Low | 10 |
| 0-20 | Moderately low | 7.5 |
| 20-40 | Moderate | 5 |
| 40-60 | Moderately High | 2.5 |
| >60 | High | 0 |

Sediment Goal Feasibility Index (“SedGlFeasin”); this index characterizes the likelihood an agricultural producer can achieve the required reduction in sediment, leaving the field to achieve the respective allowable limit for sediment. Achieving the reductions means implementing some combination of operational changes (e.g., tillage system used, type of crop planted) and agricultural conservation practices. The SedGlFeasIn index is classified with a moderate reliability weight.

The ability to achieve the percentage reduction needed to attain the field sediment allowable limit is based on the range of practice performances available from the Prioritize, Target, and Measure Application (PTMApp), or other available reliable models as described supra in the Soil Water Erosion Benchmark Index.

Based on the percentage reductions, the “method to achieve category” is assigned to the field. The method to achieve category represents typical reductions realized by different agricultural conservation practices implemented either individually or in combination. The likelihood of achieving the load reductions decreases as the percentage of the field exceeds an allowable amount increase, as shown in the following table.

| Percentage Reduction | | Numeric |
|---|---|---|
| Needed to Attain Field | | Score |
| Sediment Allowable Limit | Method to Achieve Category | Assigned |
| 0% | None | 10 |
| Up to 30% reduction | Management Practices or | 7.5 |
| | Structural Practices | |
| Up to 75% reduction | Structural Practices | 5 |
| 30-62.5% reduction | Management & Modest | 5 |
| | Structural Practices | |
| 62.5%-85% reduction | Management and Structural | 5 |
| | Practices | |
| >85% reduction | Unlikely to Achieve Reduction | 2.5 |

Resource Phosphorus Goal Index (“RePhosGlIn”); this index represents the regulatory risk to the agricultural producer (or risk their operation is scrutinized) based on the potential adverse impact to downstream lakes, reservoirs, streams, rivers, or other water bodies because of the amount of total phosphorus (attached to eroded soil and dissolved in surface water runoff) leaving the producer's field and reaching the water body. The RePhosGlIn index is classified with a moderate reliability weight.

The amount of total phosphorus trapped by conservation practices can be estimated using multiple methods, including using values from the scientific literature and models (estimated in the same way as same the Total P Mobilization Index for Agriculture). The Prioritize, Target, and Measure Application (PTMApp) (https://bwsr.state.mn.us/ptmapp) is currently used to estimate the amount of soil trapped by conservation measures.

A risk category is assigned to the field based on whether the sediment load (tons/year) leaving the field exceeds a “probable desired target” or “allowable limit” (i.e., allowed amount) for the year from the field. The field allowable amount is derived from the amount established by some entity to protect, maintain, improve or restore the water quality of the downstream water body (i.e., “target load”).

The risk category is converted into the index value by assigning a numeric score to the category, as shown in the following table.

| percent Load from Field | | Numeric |
|---|---|---|
| Exceeds Goal Amount | | Score |
| Leaving Field | Risk Category | Assigned |
| Does not exceed | Low | 10 |
| 0-20 | Moderately low | 7.5 |
| 20-40 | Moderate | 5 |
| 40-60 | Moderately High | 2.5 |
| >60 | High | 0 |

Phosphorus Goal Feasibility Index (“PhosGlFeasIn”); this index characterizes the likelihood an agricultural producer can achieve the required reduction in total phosphorus, leaving the field to meet the respective allowable regulatory limit for total phosphorus leaving a field. Achieving the reductions means implementing some combination of operational changes (e.g., tillage system used, type of crop planted) and agricultural conservation practices. The PhosGlFeasIn index is classified with a moderate reliability weight.

The ability to achieve the percentage reduction needed to attain the field total phosphorus allowable limit is based on the range of practice performances available from the literature (http://www.agronext.iastate.edu/soilfertility/info/SP435.pdf (Iowa State University Extension and Outreach, Iowa Strategy to Reduce Nutrient Loss: Nitrogen Practices/Phosphorus Practices).

Based on the percentage reductions, the “method to achieve category” is assigned to the field. The method to achieve category represents typical reductions realized by different agricultural conservation practices implemented either individually or in combination. The likelihood of achieving the load reductions decreases as the percentage of the field exceeds an allowable amount increase, as shown in the following table.

| Percentage Reduction | | |
|---|---|---|
| Needed to Attain Field | | Numeric |
| Total Phosphorus | | Score |
| Allowable Limit | Method to Achieve Category | Assigned |
| 0% | None | 10 |
| Up to 30% reduction | Management Practices or | 7.5 |
| | Structural Practices | |
| Up to 75% reduction | Structural Practices | 5 |
| 30-62.5% reduction | Management & Modest | 5 |
| | Structural Practices | |
| 62.5%-82.5% reduction | Management and Structural | 5 |
| | Practices | |
| >82.5% reduction | Unlikely to Achieve Reduction | 2.5 |

### Embodiments

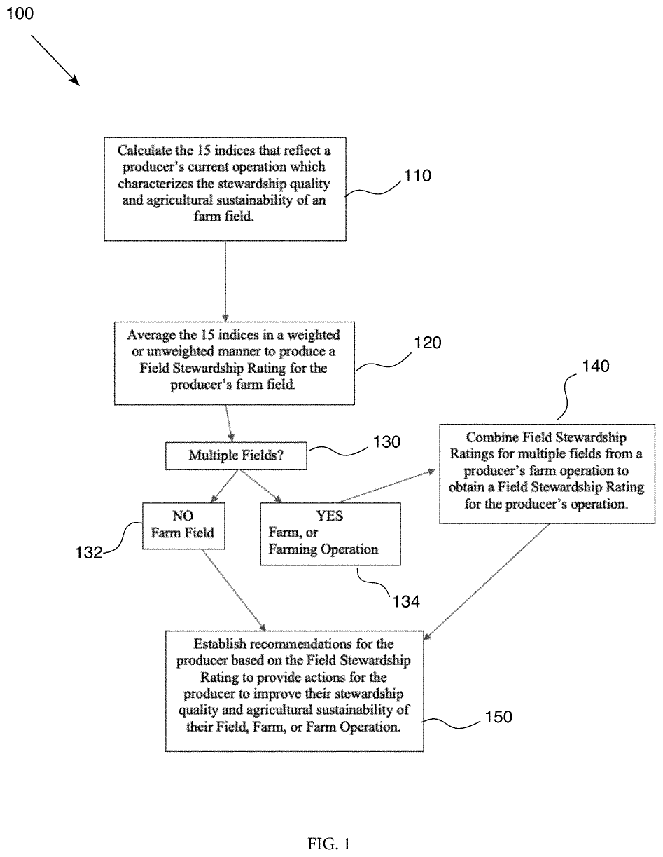

One embodiment of the method to derive a field stewardship rating is illustrated in FIG. 1 as the steps in the flow chart 100 and comprises the use of fifteen indices 110 as follows. By using the equations for each of the previously described indices these steps are taken to calculate a field stewardship rating for a single farm field: first, (a) calculate a soil water erosion benchmark index; next (b) calculate a soil water erosion departure index for agriculture; then (c) calculate a soil retention benchmark index; then (d) calculate a infiltration benchmark index; then (e) calculate a runoff departure index for agriculture; then (f) calculate a total phosphorous mobilization index for agriculture; then (g) calculate a total phosphorous export index for agriculture; then (h) calculate a total phosphorous export departure index for agriculture; followed by (i) calculate a total phosphorous retention benchmark index; then (j) determine a risk category for a resource sediment goal index and assigning a numeric score of 0 to 10; then (k) determine a method to achieve category for a sediment goal feasibility index and assigning a numeric score of 0 to 10; then (l) determine a risk category for a resource phosphorous goal index and assigning a numeric score of 0 to 10; then (m) determine a method to achieve category for a phosphorous goal feasibility index and assigning a numeric score of 0 to 10; then (n) determine a category method for a 4r nitrogen fertilizer index and assigning a numeric score of 0 to 10; then (o) determine a category method for a 4r phosphorous fertilizer index and assigning a numeric score of 0 to 10; followed by (p) calculate a total for all the previous steps of (a) through (o); and finally (q) average 120 the total to derive a field stewardship rating of the farm field.

The calculated indices 110 are combined and then averaged 120 to derive a field stewardship rating for the farm field. The FSR can then be employed to monitor the progress of a producer in managing the environmental impact of farming that particular farm field. Comparisons can be made using FSRs that have been calculated at different points in time to monitor the producer's progress. If there is no more than one field 132, then the FSR for that field can be used to establish recommendations for the producer based on the FSR to provide actions for the producer to improve their stewardship quality and agriculture sustainability of their field 150.

Otherwise, if there are multiple fields 134, e.g., a farm operation with multiple fields, then the process can be repeated by calculating the 15 indices 110 followed by the averaging of the indices 120 (the indices can be either both unweighted and weighted; only one version at a time) to derive an FSR for each of the fields in the farm operation. Then 140, the FSRs of a producer's multiple fields can be combined to obtain an FSR for the producer's farm operation.

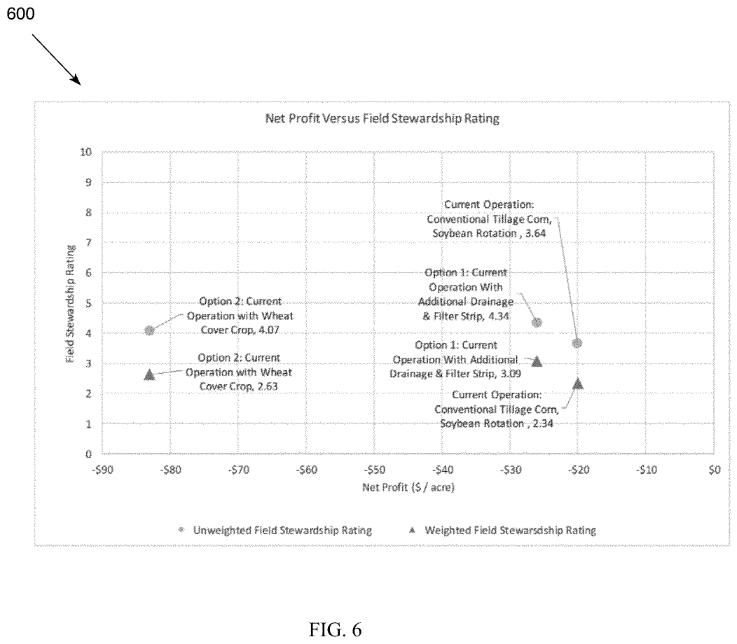

Reports can be created for producers in an effort to help assess their current operation and to help understand how operational changes may affect profitability and stewardship quality; FIG. 6 600 illustrates an example of a “Net Profit Versus Field Stewardship Rating” chart. Additional uses for such reports include helping a producer understand the relationship between their agriculture operation and the effects on water quality, assessing their regulatory risk, branding stewardship quality, and exploring means to “improve” their agriculture operation.

These reports and charts help explore, develop, test, and evaluate a farmer-led method to define and characterize stewardship quality through the lens of farm economics to better quantify stewardship quality in support of agriculture. Farmers face many challenges, including those driven by environmental policy and an ever-increasing focus on agriculture's influence on water quality and quantity (i.e., flooding).

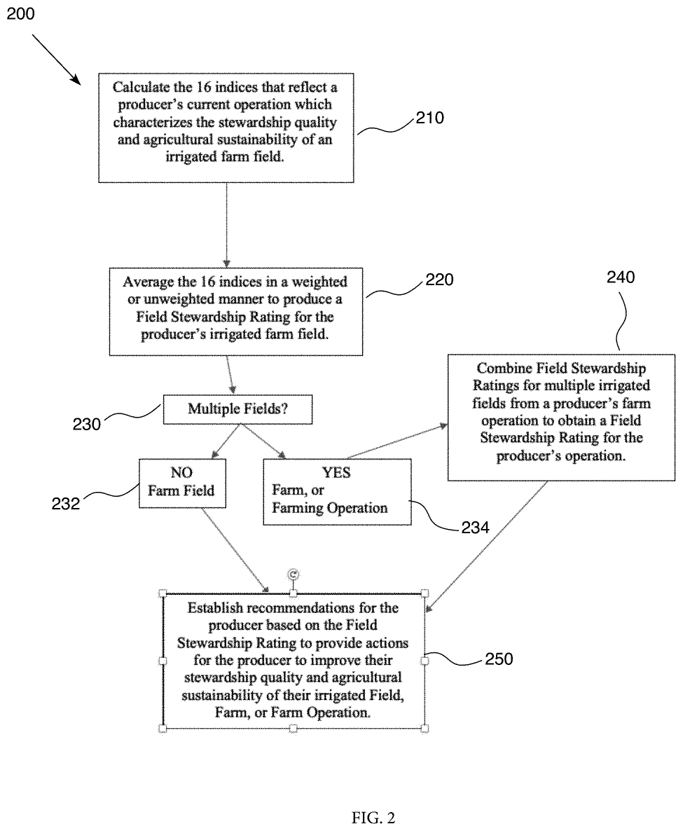

Another embodiment, illustrated in FIG. 2 of the method to derive a field stewardship rating 200 comprises the use of sixteen indices as follows. By using the equations for each of the previously described indices these steps are taken to calculate 210 a field stewardship rating for a single irrigated farm field: first, (a) calculate an irrigation water use efficiency benchmark index for an irrigated farm field; then (b) calculate a soil water erosion benchmark index; next (c) calculate a soil water erosion departure index for agriculture; then (d) calculate a soil retention benchmark index; then (e) calculate a infiltration benchmark index; then (f) calculate a runoff departure index for agriculture; then (g) calculate a total phosphorous mobilization index for agriculture; then (h) calculate a total phosphorous export index for agriculture; then (i) calculate a total phosphorous export departure index for agriculture; followed by (j) calculate a total phosphorous retention benchmark index; then (k) determine a risk category for a resource sediment goal index and assigning a numeric score of 0 to 10; then (l) determine a method to achieve category for a sediment goal feasibility index and assigning a numeric score of 0 to 10; then (m) determine a risk category for a resource phosphorous goal index and assigning a numeric score of 0 to 10; then (n) determine a method to achieve category for a phosphorous goal feasibility index and assigning a numeric score of 0 to 10; then (o) determine a category method for a 4r nitrogen fertilizer index and assigning a numeric score of 0 to 10; then (p) determine a category method for a 4r phosphorous fertilizer index and assigning a numeric score of 0 to 10; followed by (q) calculate a total for all the previous steps of (a) through (p); and finally average 220 the total to derive a field stewardship rating of the farm field.

The calculated indices 210 are combined and then averaged 220 to derive a field stewardship rating for the irrigated farm field. The FSR can then be employed to monitor the progress of a producer in managing the environmental impact of farming that particular irrigated farm field. Comparisons can be made using FSRs that have been calculated at different points in time to monitor the producer's progress. If there is no more than one irrigated field 232, then the FSR for that irrigated field can be used to establish recommendations for the producer based on the FSR to provide actions for the producer to improve their stewardship quality and agriculture sustainability of their field 250.

Otherwise, if there are multiple irrigated fields 234, e.g., a farm operation with multiple fields, then the process can be repeated by calculating the 16 indices 210 followed by the averaging of the indices 220 (the indices can be either both unweighted and weighted; only one version at a time) to derive an FSR for each of the irrigated fields in the farm operation. Then the FSRs 240 of a producer's multiple irrigated fields can be combined to obtain an FSR for the producer's farm operation 250.

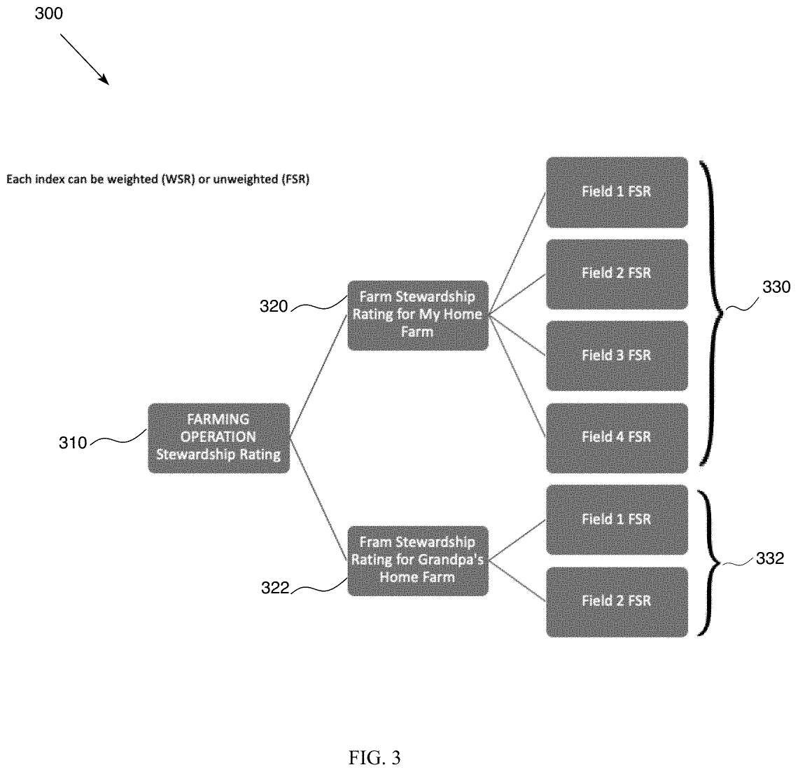

Regarding FIG. 3, where an illustration of an example of a Farming Operation 310 may be comprised of two farms, i.e., My Home Farm 320 and Grandpa's Farm 322. Wherein turn, each of the farms can consist of different numbers of fields; where My Home Farm 320 can include the set of fields 330 and Grandpa's Farm 322 can include the set of fields 332. There is no limitation to the number of fields that can be in a set of fields. Here in FIG. 3, FSRs can be derived for each group, starting with the FSRs for each field in each set, and 332. In turn, each set can then be converted into an FSR for each of the Farms 320 and 322, which may then be followed by the generation of an FSR for Farming Operation 310. To be consistent, the FSRs should be either weighted or unweighted when combined to derive the FSRs for the Farms and Farming Operations. There is no limitation on the number of farms that may be included in the derivation of an FSR for a farming operation.

Reports can be created for producers in an effort to help assess their current operation and to help understand how operational changes may affect profitability and stewardship quality; FIG. 6 600 illustrates an example of a “Net Profit Versus Field Stewardship Rating” chart. Additional uses for such reports include helping a producer understand the relationship between their agriculture operation and the effects on water quality, assessing their regulatory risk, branding stewardship quality, and exploring means to “improve” their agriculture operation.

These reports and charts help explore, develop, test, and evaluate a farmer-led method to define and characterize stewardship quality through the lens of farm economics to better quantify stewardship quality in support of agriculture. Farmers face many challenges, including those driven by environmental policy and an ever-increasing focus on agriculture's influence on water quality and quantity (i.e., flooding).

A further embodiment of the method to derive a field stewardship rating comprises the use of 15 indices of a single farm field and applying a weight to each of the indices depending on their scientific reliability. The indices may be weighted based on the scientific quality of the data used to generate their value. Each index may be assigned one of three reliability weights of either High, Moderate, or Low. A High reliability weight goes to an index that is not based on an expert's opinion, is well supported by scientific and research data, and has a known benchmark value. A Moderate reliability weight goes to an index that is based on some opinion from an expert and includes a moderate to limited amount of scientific and research data. The benchmark value for a Moderate-reliable index can also be based on a moderate to limited amount of scientific and research data. A Low reliability weight goes to an index that is based primarily on an opinion; an expert's Best Professional Judgment determines the index based on a limited amount of scientific and research data. The benchmark value for a Low-reliable index can be based on a limited amount of scientific and research data.

The further steps in this embodiment comprise assigning a reliability weight of 1, 2, or 3 to each of the indices in steps (a) through (o) of the embodiment for an FSR of a single farm field where each of the 15 indices is weighted. Then the weighted amounts for each index are added together to derive a total that is divided by 15 to obtain an average, which is also a weighted field stewardship rating for a single farm field.

An additional embodiment of the method to derive a field stewardship rating comprises the use of 16 indices for a single irrigated farm field and applying a weight to each of the indices depending on their scientific reliability. The indices may be weighted based on the scientific quality of the data used to generate their value. Each index may be assigned one of three reliability weights of either High, Moderate, or Low. A High reliability weight goes to an index that is not based on an expert's opinion, is well supported by scientific and research data, and has a known benchmark value. A Moderate reliability weight goes to an index that is based on some opinion from an expert and includes a moderate to limited amount of scientific and research data. The benchmark value for a moderate-reliable index can also be based on a moderate to limited amount of scientific and research data. A Low reliability weight goes to an index that is based primarily on an opinion; an expert's Best Professional Judgment determines the index based on a limited amount of scientific and research data. The benchmark value for a Low-reliable index can be based on a limited amount of scientific and research data.

The further steps in this embodiment comprise assigning a reliability weight of 1, 2, or 3 to each of the indices in steps (a) through (p) of the embodiment for an FSR of a single irrigated farm field where each of the 16 indices are weighted. Then the weighted amounts for each index are added together to derive a total that is divided by 16 to obtain an average which is also a weighted field stewardship rating for an irrigated single farm field.

Most agriculture operations run by a producer are composed of more than one farm field. As such, a Field Stewardship Rating can be derived for a producer's total agriculture operation by averaging all of the FSRs, from either irrigated on non-irrigated fields in a producer's agriculture operation. Therefore, an FSR can be obtained for that producer's overall operation. Just as with an FSR for a single field, an FSR for the producer's overall operation can help that producer monitor their operation's environmental impact to help achieve their goals, including the improvement of water quality. The same process can be carried out with weighted field stewardship ratings. However, an average for a producer's operation should not be derived by mixing weighted and unweighted FSRs from individual fields, either irrigated or not.

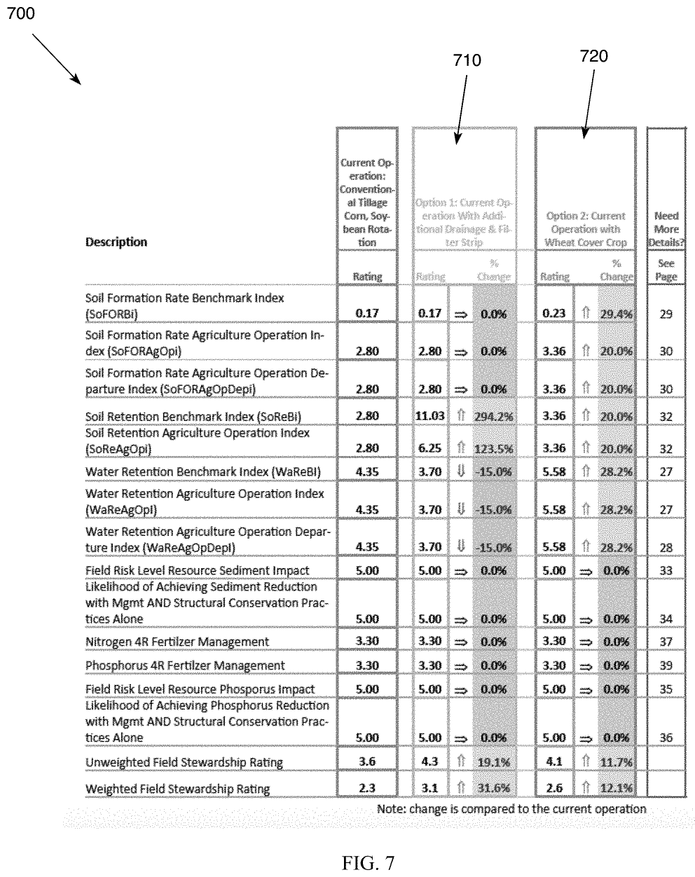

An additional embodiment is for the use of an FSR by an agriculture producer. This method allows the agriculture producer to utilize an obtained FSR for any of their fields, farms with multiple fields, or farm operations containing multiple farms. The obtained FSR can initially be used for benchmarking the stewardship quality and agricultural sustainability of the producer's current operation. From that benchmarking event, the FSR may be utilized for conceptualizing and implementing methods to improve stewardship quality and agricultural sustainability. As illustrated in FIG. 7, an example report 700 provides two options, 710, 720, for the improvement of an FSR based on the field's existing FSR results. Once implementation has occurred, then the agriculture producer may brand their operation's stewardship quality and agricultural sustainability, allowing the producer to increase the value of their agricultural products. Further steps in this embodiment may comprise estimating environmental outcomes at the subfield, field, and watershed scales; and developing strategies to improve water management and water quality.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is also intended to include features of a claim in any other independent claim, even if this claim is not directly made dependent on the independent claim.

1. A method for managing an environmental impact of an agriculture operation by deriving a field stewardship rating, the method comprising the steps:
a. calculating a soil water erosion benchmark index;
b. calculating a soil water erosion departure index for agriculture;
c. calculating a soil retention benchmark index;
d. calculating an infiltration benchmark index;
e. calculating a runoff departure index for agriculture;
f. calculating a total phosphorous mobilization index for agriculture;
g. calculating a total phosphorous export index for agriculture;
h. calculating a total phosphorous export departure index for agriculture;
i. calculating a total phosphorous retention benchmark index;
j. determining a risk category for a resource sediment goal index and assigning a numeric score of 0 to 10;
k. determining a method to achieve category for a sediment goal feasibility index and assigning a numeric score of 0 to 10;
l. determining a risk category for a resource phosphorous goal index and assigning a numeric score of 0 to 10;
m. determining a method to achieve category for a phosphorous goal feasibility index and assigning a numeric score of 0 to 10;
n. determining a category method for a 4r nitrogen fertilizer index and assigning a numeric score of 0 to 10;
o. determining a category method for a 4r phosphorous fertilizer index and assigning a numeric score of 0 to 10;
p. calculating a total for steps a. through o.;
q. averaging the total to derive a field stewardship rating of a farm field.

2. The method of claim 1 comprising the further steps of:
calculating an irrigation water use efficiency benchmark index for an irrigated farm field; and
adding the irrigation water use efficiency benchmark index to the total of steps a. through o.

3. The method of claim 1 comprising the further steps of:
assigning a reliability-weight of 1, 2, or 3 to each of the indices in steps a. through o.;
adjusting the indices scores based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o.; and
averaging the total to derive a weighted field stewardship rating for the farm field.

4. The method of claim 2 comprising the further steps of:
assigning a reliability-weight to the irrigation water use efficiency benchmark index;
assigning a reliability-weight of 1, 2, or 3 to each of the indices in steps a. through o.;
adjusting the indices scores based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o. and the irrigation water use efficiency benchmark index; and
averaging the total to derive a weighted field stewardship rating for the farm field.

5. The method of claim 1 comprising the further steps of:
obtaining values for steps a. through p. for at least one other farm field;
averaging the values for steps a. through p. for the at least one other farm field to derive a field stewardship rating for the at least one other farm field; and
combining the field stewardship rating of the farm field with the field stewardship rating of the at least one other farm field to derive a field stewardship rating for a farming operation.

6. The method of claim 2 comprising the further steps of:
calculating an irrigation water use efficiency benchmark index for at least one other irrigated farm field;
combining values for steps a. through o. for the at least one other irrigated farm field with the irrigation water use efficiency benchmark index for the at least one other irrigated farm field;
averaging the total of the combined values for steps a. through o. for the at least one other irrigated farm field with the irrigation water use efficiency benchmark index for the at least one other irrigated farm field to derive a field stewardship rating for the at least one other irrigated farm field; and
combining the field stewardship rating of the irrigated farm field with the field stewardship rating of the at least one other irrigated farm field to derive a field stewardship rating for a farming operation.

7. The method of claim 3 comprising the further steps of:
obtaining values for steps a. through o. for at least one other farm field;
assigning a reliability-weight of 1, 2, or 3 to each of the indices in steps a. through o. for the at least one other farm field;
adjusting the indices scores of the at least one other farm field based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices of the at least one other farm field in steps a. through o.;
averaging the total to derive a weighted field stewardship rating for the at least one other farm field; and
combining the weighted field stewardship rating of the farm field with the weighted field stewardship rating of the at least one other farm field to derive a weighted field stewardship rating for a farming operation.

8. The method of claim 4 comprising the further steps of:
obtaining values for steps a. through o. for at least one other irrigated farm field;
calculating an irrigation water use efficiency benchmark index for the at least one other irrigated farm field;
assigning a reliability-weight of 1, 2, or 3 to each of the indices in steps a. through o. and the irrigation water use efficiency benchmark index for the at least one other irrigated farm field, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o. and the irrigation water use efficiency benchmark index for the at least one other irrigated farm field; and
averaging the total to derive a weighted field stewardship rating for the at least one other irrigated farm field; and
combining the weighted field stewardship rating of the irrigated farm field with the weighted field stewardship rating of the at least one other irrigated farm field to derive a weighted field stewardship rating for a farming operation.

9. A method of use of a field stewardship rating, the method comprising the steps:
obtaining a field stewardship rating for at least one farm field by,
a. calculating a soil water erosion benchmark index;
b. calculating a soil water erosion departure index for agriculture;
c. calculating a soil retention benchmark index;
d. calculating an infiltration benchmark index;
e. calculating a runoff departure index for agriculture;
f. calculating a total phosphorous mobilization index for agriculture;
g. calculating a total phosphorous export index for agriculture;
h. calculating a total phosphorous export departure index for agriculture;
i. calculating a total phosphorous retention benchmark index;
j. determining a risk category for a resource sediment goal index and assigning a numeric score of 0 to 10;
k. determining a method to achieve category for a sediment goal feasibility index and assigning a numeric score of 0 to 10;
l. determining a risk category for a resource phosphorous goal index and assigning a numeric score of 0 to 10;
m. determining a method to achieve category for a phosphorous goal feasibility index and assigning a numeric score of 0 to 10;
n. determining a category method for a 4r nitrogen fertilizer index and assigning a numeric score of 0 to 10;
o. determining a category method for a 4r phosphorous fertilizer index and assigning a numeric score of 0 to 10;
p. calculating a total for steps a. through o.; and
q. averaging the total to derive a field stewardship rating of the at least one farm field;
benchmarking an agriculture operation, wherein the benchmarking is determined from at least one farm filed in the agriculture operation;
conceptualizing methods to improve the field stewardship rating of the agriculture operation;
implementing the methods to improve the field stewardship rating of the agriculture operation; and
branding the agriculture operation with the improved field stewardship rating.

10. The method of claim 9 comprising the further steps of:
estimating an environmental outcome for the agriculture operation; and
developing strategies to improve water management and water quality.

11. The method of claim 9 comprising the further steps of:
calculating an irrigation water use efficiency benchmark index for an irrigated farm field; and
adding the irrigation water use efficiency benchmark index to the total of steps a. through o.

12. The method of claim 9 comprising the further steps of:
assigning a reliability-weight of 1, 2, or 3 to each of the indices in steps a. through o.;
adjusting the indices scores based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o.; and
averaging the total to derive a weighted field stewardship rating for the farm field.

13. The method of claim 11 comprising the further steps of:
assigning a reliability-weight to the irrigation water use efficiency benchmark index;
assigning a reliability-weight of 1, 2, or 3 to each of the indices in steps a. through o.;
adjusting the indices scores based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o. and the irrigation water use efficiency benchmark index; and
averaging the total to derive a weighted field stewardship rating for the farm field.

14. The method of claim 9 comprising the further steps of:
obtaining values for steps a. through p. for at least one other farm field;
averaging the values for steps a. through p. for the at least one other farm field to derive a field stewardship rating for the at least one other farm field; and
combining the field stewardship rating of the farm field with the field stewardship rating of the at least one other farm field to derive a field stewardship rating for a farming operation.

15. The method of claim 11 comprising the further steps of:
calculating an irrigation water use efficiency benchmark index for at least one other irrigated farm field;
combining values for steps a. through o. for the at least one other irrigated farm field with the irrigation water use efficiency benchmark index for the at least one other irrigated farm field;
averaging the total of the combined values for steps a. through o. for the at least one other irrigated farm field with the irrigation water use efficiency benchmark index for the at least one other irrigated farm field to derive a field stewardship rating for the at least one other irrigated farm field; and
combining the field stewardship rating of the irrigated farm field with the field stewardship rating of the at least one other irrigated farm field to derive a field stewardship rating for a farming operation.

16. The method of claim 12 comprising the further steps of:
obtaining values for steps a. through o. for at least one other farm field;
assigning a reliability-weight of 1, 2, or 3 to each of the indices in steps a. through o. for the at least one other farm field;
adjusting the indices scores of the at least one other farm field based on their reliability-weight, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices of the at least one other farm field in steps a. through o.;
averaging the total to derive a weighted field stewardship rating for the at least one other farm field; and
combining the weighted field stewardship rating of the farm field with the weighted field stewardship rating of the at least one other farm field to derive a weighted field stewardship rating for a farming operation.

17. The method of claim 13 comprising the further steps of:
obtaining values for steps a. through o. for at least one other irrigated farm field;
calculating an irrigation water use efficiency benchmark index for the at least one other irrigated farm field;
assigning a reliability-weight of 1, 2, or 3 to each of the indices in steps a. through o. and the irrigation water use efficiency benchmark index for the at least one other irrigated farm field, wherein the indices with the reliability-weight of 1 are multiplied by ⅓, the indices with the reliability-weight of 2 are multiplied by ⅔, and the indices with the reliability-weight of 3 are multiplied by 1;
calculating a total for the adjusted indices in steps a. through o. and the irrigation water use efficiency benchmark index for the at least one other irrigated farm field; and
averaging the total to derive a weighted field stewardship rating for the at least one other irrigated farm field; and
combining the weighted field stewardship rating of the irrigated farm field with the weighted field stewardship rating of the at least one other irrigated farm field to derive a weighted field stewardship rating for a farming operation.
